(19) United States
(12) Patent Application Publication
(10) Pub. No.: US 2025/0106365 A1
(43) Pub. Date: Mar. 27, 2025

(54) CONTROL OF CAMERA MONITORING SYSTEM

(71) Applicant: Volvo Truck Corporation, Göteborg (SE)

(72) Inventors: Yann QUIBRIAC, Lyon (FR); Julien Therien, Marsonnas (FR)

(21) Appl. No.: 18/829,687

(22) Filed: Sep. 10, 2024

(30) Foreign Application Priority Data
Sep. 22, 2023 (EP) 23199006.0

(51) Int. Cl. H04N 7/18; H04N 23/611; H04N 23/65

(52) U.S. Cl. CPC H04N 7/188; H04N 7/181; H04N 23/611; H04N 23/651

(57) ABSTRACT

A computer system comprises processing circuitry configured to control a surveillance system to operate at a power saving state for a predetermined sleep time of a first surveillance cycle. The processing circuitry is further configured to, upon lapse of the predetermined sleep time, control the surveillance system to operate at a detection power state and at the detection power state, control the surveillance system to obtain first image data of a surrounding area of a vehicle. The processing circuitry is further configured to, at the detection power state, process the first image data to determine whether at least one predetermined target is in the surrounding area and upon determining that the predetermined target is not present in the surrounding area, control the surveillance system to operate at the power saving state for the predetermined sleep time of a second surveillance cycle following the first surveillance cycle.

### PRIORITY APPLICATIONS

The present application claims priority to European Patent Application No. 23199006.0, filed on Sep. 22, 2023, and entitled “CONTROL OF CAMERA MONITORING SYSTEM,” which is incorporated herein by reference in its entirety.

### TECHNICAL FIELD

The disclosure relates generally to control of surveillance systems. In particular aspects, the disclosure relates to control of camera monitoring systems for surveillance of a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Significant advancements are being made to enhance vehicle safety and security. Surveillance systems for heavy-duty vehicles help ensure the well-being of drivers, passengers, and cargo. These systems are designed to monitor, record, and analyze activities both inside and outside the vehicle, providing real-time and valuable information and valuable insights to fleet managers and operators.

### SUMMARY

According to a first aspect of the disclosure, a computer system is presented. The computer system comprises processing circuitry configured to control a surveillance system to operate at a power saving state for a predetermined sleep time of a first surveillance cycle and upon lapse of the predetermined sleep time, control the surveillance system to operate at a detection power state. The processing circuitry is further configured to, at the detection power state, control the surveillance system to obtain first image data of a surrounding area of a vehicle and at the detection power state, process the first image data to determine whether at least one predetermined target is in the surrounding area. The processing circuitry is further configured to upon determining that the predetermined target is not present in the surrounding area, control the surveillance system to operate at the power saving state for the predetermined sleep time of a second surveillance cycle following the first surveillance cycle. The first aspect of the disclosure may seek to reduce a risk that an electrical power system of a vehicle is depleted. A technical benefit may include reducing an average power consumption (e.g. current consumption) of a surveillance system while avoiding altering a degree of protection provided by the surveillance system.

Optionally in some examples, including in at least one preferred example, processing circuitry is further configured to, during the second surveillance cycle, upon lapse of the predetermined sleep time, control the surveillance system to operate at the detection power state and at the detection power state, control the surveillance system to obtain second image data of the surrounding area of the vehicle. The processing circuitry is further configured to, at the detection power state, process the second image data to determine whether at least one predetermined target is in the surrounding area, and upon determining that the predetermined target is not present in the surrounding area, control the surveillance system to operate at the power saving state for the predetermined sleep time of a third surveillance cycle following the second surveillance cycle. A technical benefit may include reducing an average power consumption of a surveillance system while avoiding altering a degree of protection provided by the surveillance system.

Optionally in some examples, including in at least one preferred example, the processing circuitry is further configured to, at the detection power state, upon determining that the predetermined target is present in the surrounding area, control the surveillance system to operate at a monitoring power state. A technical benefit may include allowing the surveillance system to consume more power when a predetermined target is present in the surrounding area which reduces a risk that the degree of protection provided by the surveillance system is reduced.

Optionally in some examples, including in at least one preferred example, the second image data to determine whether the at least one predetermined target is present in the surrounding area by processing the image data further comprises processing the image data by comparison of the second image data to the first image data. A technical benefit may include providing a low power and efficient function of determining if a predetermined target is present in the surrounding area. This further reduces an average power consumption of the surveillance system while avoiding altering a degree of protection provided by the surveillance system.

Optionally in some examples, including in at least one preferred example, the processing circuitry is further configured to, at the detection power state, upon determining that the second image data is substantially different from the first image data, further process the first image data by an item recognition circuitry to determine presence of the predetermined target in the surrounding area. A technical benefit may include providing a low power and efficient function of determining if a predetermined target is present in the surrounding area and not consume more power than required in determining if the predetermined target is present in the surrounding area. This further reduces an average power consumption of the surveillance system while avoiding altering a degree of protection provided by the surveillance system.

Optionally in some examples, including in at least one preferred example, the processing circuitry is further configured to, at the detection power state, obtain the first image data from the surveillance system, wherein the surveillance system comprises a plurality of image sensor systems. A technical benefit may include providing select first image data relevant to a current situation and/or based on historic data.

Optionally in some examples, including in at least one preferred example, the processing circuitry is further configured to: obtain image data from a first image sensor subset comprising at least one image sensor system of the plurality of image sensor systems at the first surveillance cycle, and obtain image data from a second image sensor subset comprising at least one image sensor system of the plurality of image sensor systems at the second surveillance cycle, wherein the first image sensor subset is different from the second image sensor subset. A technical benefit may include monitoring a more complete area surrounding the vehicle thereby allowing the average power consumption of the surveillance system to be decreased while avoiding altering a degree of protection provided by the surveillance system.

Optionally in some examples, including in at least one preferred example, the processing circuitry is further configured to upon a lapse of the predetermined sleep time of each surveillance cycle, control a subset of a plurality of image sensor systems of the surveillance system to operate at the detection power state, wherein each subset of the plurality of image sensor systems is cycled through in an order, the order being at least one of, a predetermined order, a variable order determined depending on targets detected, a random order. A technical benefit may include monitoring a more complete area surrounding the vehicle thereby allowing the average power consumption of the surveillance system to be decreased while avoiding altering a degree of protection provided by the surveillance system.

Optionally in some examples, including in at least one preferred example, the processing circuitry is further configured to: during the second surveillance cycle, upon lapse of the predetermined sleep time, control the surveillance system to operate at the detection power state; at the detection power state, control the surveillance system to obtain second image data of the surrounding area of the vehicle; at the detection power state, process the second image data to determine whether at least one predetermined target is in the surrounding area; upon determining that the predetermined target is not present in the surrounding area, control the surveillance system to operate at the power saving state for the predetermined sleep time of a third surveillance cycle following the second surveillance cycle; at the detection power state, upon determining that the predetermined target is present in the surrounding area, control the surveillance system to operate at a monitoring power state; at the detection power state, upon determining that the second image data is substantially different from the first image data, further process the first image data by an item recognition circuitry to determine presence of the predetermined target in the surrounding area; at the detection power state, obtain the first image data from the surveillance system, wherein the surveillance system comprises a plurality of image sensor systems; obtain image data from a first image sensor subset comprising at least one image sensor system of the plurality of image sensor systems at the first surveillance cycle, and obtain image data from a second image sensor subset comprising at least one image sensor system of the plurality of image sensor systems at the second surveillance cycle, wherein the first image sensor subset is different from the second image sensor subset; and upon a lapse of the predetermined sleep time of each surveillance cycle, control a subset of a plurality of image sensor systems of the surveillance system to operate at the detection power state, wherein each subset of the plurality of image sensor systems is cycled through in an order, the order being at least one of, a predetermined order, a variable order determined depending on targets detected, a random order. wherein processing the second image data to determine whether the at least one predetermined target is present in the surrounding area by processing the image data further comprises processing the image data by comparison of the second image data to the first image data. A technical benefit may include any of the benefits mention in reference to the previous examples.

According to a second aspect of the disclosure, a vehicle comprising the computer system of the first aspect is presented. The second aspect of the disclosure may seek to reduce a risk that an electrical power system of a vehicle is depleted. A technical benefit may include providing surveillance of the vehicle for extended periods of time with a reduced risk of depleting an electrical power system of the vehicle.

Optionally in some examples, including in at least one preferred example, the power saving state is entered responsive to the vehicle being parked. A technical benefit may include automatically providing surveillance and safety of vehicle and/or driver at parked situations with a reduced risk of depleting the electrical power system of the vehicle.

Optionally in some examples, including in at least one preferred example, the vehicle is a heavy-duty vehicle. A technical benefit may include protection of the generally expensive vehicles and any cargo hauled by the vehicle.

According to a third aspect of the disclosure, a computer implemented method is presented. The computer implemented method comprises, controlling, by processing circuitry of a computer system, surveillance system to operate at a power saving state for a predetermined sleep time of a first surveillance cycle. The computer implemented method further comprises, upon lapse of the predetermined sleep time, controlling, by the processing circuitry of the computer system, the surveillance system to operate at a detection power state and at the detection power state, controlling, by the processing circuitry of the computer system, the surveillance system to obtain first image data of a surrounding area of a vehicle. computer implemented method comprises, at the detection power state, processing, by the processing circuitry of the computer system, the first image data to determine whether at least one predetermined target is in the surrounding area and upon determining that the predetermined target is not present in the surrounding area, controlling, by the processing circuitry of the computer system, the surveillance system to operate at the power saving state for the predetermined sleep time of a second surveillance cycle following the first surveillance cycle. The third aspect of the disclosure may seek to reduce a risk that an electrical power system of a vehicle is depleted. A technical benefit may include reducing an average power consumption of a surveillance system while avoiding altering a degree of protection provided by the surveillance system.

According to a fourth aspect of the disclosure, a computer program product is presented. The computer program product comprises program code for performing, when executed by the processing circuitry, the method of the third aspect. The fourth aspect of the disclosure may seek to reduce a risk that an electrical power system of a vehicle is depleted. A technical benefit may include reducing an average power consumption of a surveillance system while avoiding altering a degree of protection provided by the surveillance system.

According to a fifth aspect of the disclosure, a non-transitory computer-readable storage medium is presented. The non-transitory computer-readable storage medium comprises instructions, which when executed by the processing circuitry, cause the processing circuitry to perform the method of the third aspect. The fifth aspect of the disclosure may seek to reduce a risk that an electrical power system of a vehicle is depleted. A technical benefit may include reducing an average power consumption of a surveillance system while avoiding altering a degree of protection provided by the surveillance system.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary network diagram of a vehicle and surveillance according to an example.

FIG. 2 is an exemplary top view of a vehicle and surveillance system according to an example.

FIG. 3 is a schematic view of a surveillance system manager according to an example.

FIG. 4 is a flow chart for controlling a surveillance system according to an example.

FIG. 5 is a state change diagram of a surveillance system according to an example.

FIG. 6 is a schematic view of a computer system controlling a surveillance system according to an example.

FIG. 7 is a block diagram of a method for controlling a surveillance system according to an example.

FIG. 8 is a schematic view of a computer program product according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

One purpose of surveillance systems for heavy-duty vehicles is to augment safety, security, and efficiency within the transportation sector. By utilizing advanced technologies such as cameras, sensors, and connectivity solutions, these systems are intended to address various challenges faced by fleet operators, including accident prevention, driver monitoring, cargo protection, and/or compliance with industry regulations.

Surveillance systems in vehicles generally comprise high-resolution cameras. These cameras are strategically installed in and around the vehicle to capture a comprehensive view of the surroundings, both within the cabin and the external environment. Some surveillance systems comprise cameras offering night vision capabilities, wide-angle lenses, and high frame rates to ensure clear and accurate footage. To complement the camera's vision, surveillance systems generally comprise various sensors. These may include proximity sensors, collision detection sensors, and tire pressure monitoring sensors, among others. These sensors provide data to the surveillance system, contributing to real-time alerts and facilitating data analysis. Surveillance systems help protect valuable cargo from theft, damage, and tampering during transportation. They act as a deterrent to potential thieves and assist in the investigation of any suspicious activities.

However, generally, the more advanced the surveillance system, the higher the power consumption of the surveillance system. This may become an issue for parked vehicles when surveillance systems may have to be powered from an on-board battery of the vehicle.

The teachings of the present disclosure provide methods, systems, functions and devices that may reduce power consumption of surveillance systems. By providing a selective activation of an image circuitry of a surveillance system, power consumption may be decreased. The selective activation may be described as punctual image monitoring and/or a periodic image monitoring. The image circuitry may capture one or more images, and if no suspicious person or object is detected in these images, the image circuitry may go to sleep for a predetermined time before it wakes up again and captures one or more additional imaged. The frame rate may be increased if a suspicious person or object is detected in the captured images.

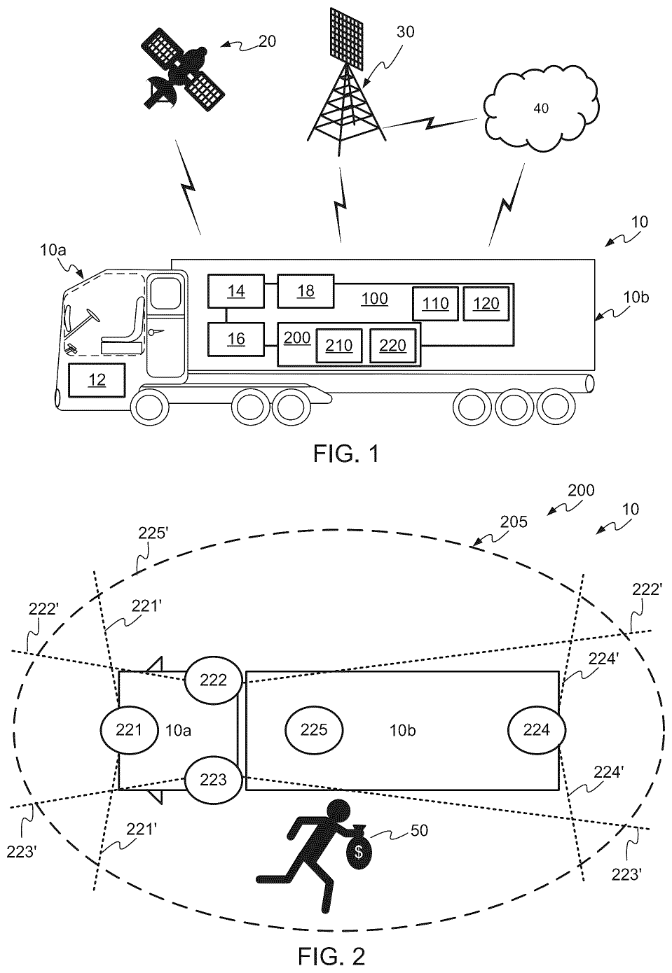

FIG. 1 is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 14 suitable for providing energy for the propulsion source 12. That is to say, if the propulsion source 12 is an electrical motor, a suitable energy source 14 would be a battery or a fuel cell. The vehicle 10 further comprises sensor circuitry 16 arranged to detect, measure, sense or otherwise obtain data relevant for operation of the vehicle 10. The sensor circuit 16 may comprise one or more of an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor etc. Operational data relevant for operation of the vehicle 10 may include, but is not limited to, one or more of a speed of the vehicle 10, a weight of the vehicle 10, an inclination of the vehicle 10, a status of the energy source 14 of the vehicle 10 (state of charge, fuel level etc.), a current speed limit of a current road travelled by the vehicle 10, etc. The vehicle 10 may further comprise communications circuitry 18 configured to receive and/or send communication. The communications circuitry 18 may be configured to enable the vehicle 10 to communicate with one or more external devices or systems such as a cloud server 40. The communication with the external devices or systems may be directly or via a communications interface such as a cellular communications interface 30, such as a radio base station. The cloud server 40 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 18 may, additionally or alternatively, be configured to enable the vehicle 10 to be operatively connected to a Global Navigation Satellite System (GNSS) 20 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 20 to determine a geographical location of the vehicle 10.

The vehicle 10 in FIG. 1 further comprises a surveillance system 200 and a computer system 100. The computer system 100 may be operatively connected to the surveillance system 200, the communications circuitry 18, the sensor circuitry 16, the energy source 14 and/or the propulsion source 12 of the vehicle 10. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The surveillance system 200 may comprise surveillance system processing circuitry 210, the surveillance system processing circuitry 210 may be part of the processing circuitry 110 of the computer system 100. The surveillance system 200 may comprise one or more image sensor systems 220. An image sensor system 220 comprises one or more image sensors configured to sense, detect, measure or otherwise obtain image data of an inside or outside of the vehicle 10. The image sensor system 220 may be referred to as a camera monitoring system. The image sensor system 220 may be configured to capture still image data (still images) or a series of images forming video image data (video images). Still images are static visual representations captured using cameras or other imaging devices. Still images capture a single moment in time and do not have any motion or movement. A still image is a single frame, a snapshot frozen in time, capturing a specific scene or subject at a particular instance. A still image represents a single perspective or viewpoint. Still image data may be provided in any suitable format, exemplified by, but not limited to JPEG, PNG, GIF, or RAW. A video image is a series of still images played in rapid succession, creating the illusion of motion. It is substantially a sequence of continuous frames captured over time, resulting in a moving visual representation. Video images consist of multiple frames played one after another at a high speed, typically at 15, 24, 30, or 60 frames per second (FPS) although higher and lower frame rates may very well be considered. This creates the perception of motion, allowing viewers to see events unfolding over time. Video image data may be provided in any suitable format, exemplified by, but not limited to MP4, AVI, MOV, or MKV.

In FIG. 2, a top view of an exemplary vehicle 10 is shown. The vehicle 10 comprises a surveillance system 200 configured to monitor a surrounding area 205 of the vehicle 10. In FIG. 2, the surveillance system 200 comprises a plurality of image sensor systems 220, i.e. a front view image sensor system 221, a rear view image sensor system 224, a right view image sensor system 222, a left view image sensor system 223 and a birds view image sensor system 225. The front view image sensor system 221 is configured to monitor an area in front of the vehicle 10, in FIG. 2 delimited by front view delimiters 221′. The rear view image sensor system 224 is configured to monitor an area behind the vehicle 10, in FIG. 2 delimited by rear view delimiters 224′. The right view image sensor system 222 is configured to monitor an area to the right of the vehicle 10 (curb view camera in countries with right hand traffic), in FIG. 2 delimited by right view delimiters 222′. The left view image sensor system 223 is configured to monitor an area to the left of the vehicle 10 (curb view camera in countries with left hand traffic), in FIG. 2 delimited by left view delimiters 223′. The birds view image sensor system 225 is configured to monitor an area around vehicle 10, in FIG. 2 delimited by a bird view delimiter 225′. It should me mentioned that the location and field of views of the image sensor systems 221, 222, 223, 224, 225 in FIG. 2 are exemplary. In some examples, one or more of the image sensor systems 221, 222, 223, 224, 225 are configured with a 360° field of vies provide by e.g. one or more fishbowl lenses.

In FIG. 2, the image sensor systems 221, 222, 223, 224, 225 are all mounted on the vehicle 10. This is one example, in other examples, one, some or all image sensor systems 220 are remote from the vehicle 10. This may be the case when the vehicle 10, by the communication circuitry 18, is operatively connected to image sensor systems 220 in e.g. parking garages etc. Further to this, in some examples, the vehicle 10 may comprise further image sensor systems 220 monitoring additional or overlapping areas around the vehicle 10. Two or more image sensor systems 220 may very well monitor substantially the same area around the vehicle 10, such configurations may be provided when one image sensor system 220 is an image sensor system configured for IR wavelength (a thermal system) and another image sensor system is a an image sensor system 220 configured for wavelengths seen by a human eye. A vehicle 10 according to the present disclosure may comprise any number of image sensor systems 220 and any combination of the image sensor systems 221, 222, 223, 224, 225 exemplified in FIG. 2.

The surveillance system 200 is configured to detect suspicious activity. The suspicious activity may comprise a predetermined target 50 being present in the surrounding area 205 of the vehicle 10. In FIG. 2, the predetermined target 50 is exemplified by a burglar running away, but this is for illustrative purposes only. The predetermined target 50 may be any type of object or person in the surrounding area 205 of the vehicle 10. Predetermined targets 50 may be persons or vehicles present in the surrounding area 205 of the vehicle 10. The predetermined targets 50 may be defined by a movement speed or movement pattern of persons or vehicles present in the surrounding area 205 of the vehicle 10. For instance, a person approaching the vehicle 10 and stopping in the surrounding area 205 of the vehicle 10 may be considered a predetermined target 50, while a person walking at a steady pace towards the vehicle 10 passing the vehicle 10 may not be considered a predetermined target 50. More advanced classifications where a stance of a person (crouching, crawling etc.) may be considered in defining what constitutes a predetermined target 50.

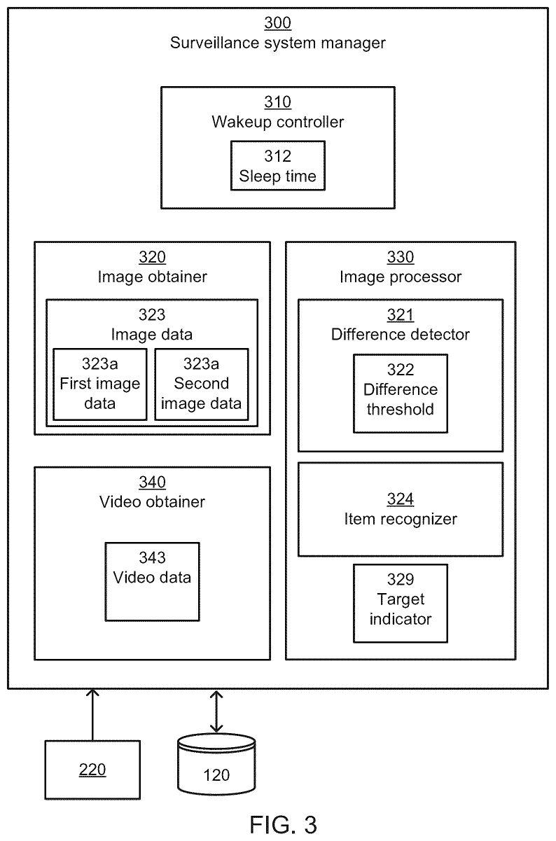

In FIG. 3, a block diagram of an architecture of a surveillance system manager 300 is shown. The computer system 100 and/or the surveillance system processing circuitry 210 may be configured to provide the functions and features of the surveillance system manager 300.

The surveillance system manager 300 comprises a wakeup controller 310. The wakeup controller 310 is configured to wake the surveillance system manager 300 from a low power state. The wakeup controller 310 may be configured to wake the surveillance system manager 300 upon lapse of a predetermined sleep time 312. The wakeup controller 310 may be configured as a watchdog timer configured to generate an interrupt or other data upon lapse of the predetermined sleep time 312. In some examples the predetermined sleep time 312 is a configurable sleep time controlled by the surveillance system manager 300. In some examples, the predetermined sleep time 312 is a fixed sleep time of 30 s or less. In some examples, the predetermined sleep time 312 is a fixed sleep time of 15 s or less. In some examples, the predetermined sleep time 312 is a fixed sleep time of 5 s or less. In some examples, the predetermined sleep time 312 is a random sleep time below a maximum sleep time. The maximum sleep time may be 30 s or less. A minimum value accepted for the predetermined sleep time 312 may be determined by hardware constraints of the system 100, 200 implementing the wakeup controller 310 such as a system clock frequency etc.

The surveillance system manager 300 further comprises a low frame rate image obtainer 320, image obtainer 320 for short. The low frame rate image obtainer 320 is configured to obtain low frame rate image data 323, image data 323 for short, from one or more image sensor systems 220 of the surveillance system 200. The low frame rate image data 323 may be zero frame rate image data, i.e. still images. The low frame rate image obtainer 320 may be configured to obtain low frame rate image data 323 from any image sensor system 220 of the surveillance system 200. In some examples, each time the low frame rate image obtainer 320 is activated, it may be configured to obtain low frame rate image data 323 from an image sensor systems 220 that is different from an image sensor systems 220 from which image data 323 was obtained at a previous activation of the low frame rate image obtainer 320. In some examples, the image obtainer 320 may be configured to, temporarily or persistently, store historic low frame rate image data 323 as previous low frame rate image data 323b, or a second low frame rate image data 323b. Current, or latest image data 323 may sometimes be referred to as current low frame image data 323a or first low frame rate image data 323a. In some examples, the previous low frame rate image data 323b is stored in the storage device 120.

To exemplify, assume the image sensor systems 221, 222, 223, 224, 225 of FIG. 2. The low frame rate image data 323 may be configured to cycle through the image sensor systems 221, 222, 223, 224, 225 by activating different image sensor systems 221, 222, 223, 224, 225 each time the low frame rate image obtainer 320 is activated. For instance, the low frame rate image obtainer 320 may be configured to obtain low frame rate image data 323 from the front view image sensor system 221 at a first activation, and to obtain low frame rate image data 323 from the rear view image sensor system 224 at a second activation, and so on cycling through the image sensor systems 221, 222, 223, 224, 225. The low frame rate image obtainer 320 may be configured to obtain low frame rate image data 323 from a subset of the image sensor systems 221, 222, 223, 224, 225 each time the low frame rate image obtainer 320 is activated. A first subset may comprise the front view image sensor system 221 and the right side image sensor system 223. A second subset may comprise the rear view image sensor system 224 and the right side image sensor system 223. A third subset may comprise the left view image sensor system 224, the rear view image sensor system 224 and the front view image sensor system 221. A fourth subset may comprise the birds view image sensor system 225. As seen from this example, the same image sensor systems 221, 222, 223, 224, 225 may form part of different subsets and each subset may comprise just one image sensor systems 221, 222, 223, 224, 225 or a plurality of image sensor systems 221, 222, 223, 224, 225. An order of how the image sensor systems 221, 222, 223, 224, 225 or the subsets of image sensor systems 221, 222, 223, 224, 225 are cycled through may be a predetermined order, a variable order determined depending on the low frame rate image data 323, or a random order.

The low frame rate image obtainer 320 may be configured to store the low frame rate image data 323 on a storage device, e.g. the storage device 120 of the computer system 100.

The surveillance system manager 300 further comprises an image processor 330. The image processor 330 is configured to process the low frame rate image data 323 obtained by the low framerate image obtainer 320 to determine presence of at least one predetermined target 50 in the low frame rate image data 323.

The image processor 321 may comprise a difference detector 321 configured to compare the low frame rate image data 323a to the previous low frame rate image data 323b obtained from the same image sensor system 220. If there is a difference between the two sets of low frame rate image data 323, the image processor 330 may be configured to provide a target indicator 329 indicating that the predetermined target 50 is preset in the low frame rate image data 323. Determining if there is a difference between the current low frame rate image data 323a and the previous low frame rate image data 323b may be done in one or more different ways such as pixel-wise comparison, mean squared error (MSE), structural similarity index (SSI), histogram comparison etc. Pixel-wise comparison involves directly comparing the pixel values of corresponding pixels in the two sets of low frame rate image data 323. An absolute or squared difference between the pixel values can be calculated to quantify the dissimilarity. MSE is a metric used to measure the average squared difference between the pixel values of two images where a lower MSE values indicate greater similarity between the two sets of low frame rate image data 323. SSI is a metric that takes into account not only pixel-wise differences but also the structural information of the two sets of low frame rate image data 323. SSI is designed to provide a more accurate assessment of perceived image quality. Histograms of pixel intensities may be computed for both sets of low frame rate image data 323, and their differences may be quantified using various metrics like histogram intersection, Bhattacharyya distance, or Earth Mover's Distance, etc. Detecting a difference between the two sets of low frame rate image data 323 is a simple, low power and fast way of determining presence of the predetermined target 50 in the low frame rate image data 323. In order to ensure that minor shift in the low frame rate image data 323 does not provide a target indicator 329 indicating that the predetermined target 50 is preset in the low frame rate image data 323, the difference between the two sets of low frame rate image data 323 may have to be greater than a difference threshold 322 in order to provide a target indicator 329 indicating that the predetermined target 50 is preset in the low frame rate image data 323. The difference threshold 322 may be a percentage difference indicating a number of pixels being different between the two sets of low frame rate image data 323. The previous low frame rate image data 323b may be provided as an average of a plurality of sets of previous low frame rate image data 323b.

As an alternative to, or in addition to, the difference detector 321, the image processor 330 may comprise an item recognizer 324. The item recognizer 324 may be configured to recognize features in the low frame rate image data 323. Feature recognition may involve extracting distinctive features from the low frame rate image data 323, such as edges, corners or descriptors, and then matching. The feature recognition of the item recognizer 324 may be paired with the difference detector 321 such that a target indicator 329 indicating that the predetermined target 50 is preset in the low frame rate image data 323 is provided if new and/or changed features are present in the low frame rate image data 323.

In some examples, the item recognizer 324 may be configured to perform object recognition in the low frame rate image data 323. Object recognition may performed in numerous ways and generally involves computer vision techniques and machine learning algorithms to identify and classify objects within the low frame rate image data 323. Object recognition may comprise preprocessing of the low frame rate image data 323 e.g. resizing, normalization, converting the low frame rate image data 323 etc. The reprocessed low frame rate image data 323 is subjected to feature extraction wherein meaningful features are extracted from the low frame rate image data 323 that may represent the objects present in it. Features may be simple, such as the above exemplified edges, corners, and descriptors or more complex, like deep learning-based features extracted from convolutional neural networks (CNNs). The extracted features may be represented in a format that is suitable for further analysis. This may involve flattening the features into a vector or using more advanced techniques like feature histograms etc. In supervised machine learning, a labeled dataset is provided to train the item recognizer 324. This dataset comprises images along with corresponding class labels, which indicate the objects present in the images. Using the labeled dataset, a machine learning algorithm may be trained to learn patterns and relationships between the extracted features and the corresponding object labels. Common machine learning algorithms for object recognition comprise support vector machines (SVMs), random forests, and deep learning-based methods like CNNs. Once the model is trained, the model may be used to classify new, unseen images. The image is first preprocessed and features are extracted, just like in the training phase. Then, the trained model predicts the class label of the object(s) in the image based on the extracted features. The item recognizer 324 may be configured to provide post-processing to improve the object recognition results. The post-processing may comprise non-maximum suppression to eliminate duplicate detections, and thresholding may be applied to filter out low-confidence predictions.

The item recognizer 324 is generally computationally heavier than the difference detector 321. To this end, in some examples, the item recognizer 324 is only executed responsive to the difference detector 321 detecting a difference between the two sets of low frame rate image data 323.

The surveillance system manager 300 may further comprises a high frame rate image obtainer 340, video obtainer 340 for short. The high frame rate image obtainer 340 is configured to obtain high frame rate image data 343, video data 343 for short, from one or more image sensor systems 220 of the surveillance system 200. The high frame rate image data 343 may have any frame rate being higher than the frame of the low frame rate image data 323. In order to limit an amount of data storage needed (if the high frame rate image data 343 is stored at e.g. the storage device 120 of the computer system 100), the frame rate of the high frame rate image data 343 may be 5-20 fps, such as 15 fps. To increase smoothness of motions, the frame rate of the high frame rate image data 343 may be 20-40 fps, such as 30 fps. In order to capture fast moving objects and/or fine details, the frame rate of the high frame rate image data 343 may be 40-100 fps, such as 60 fps.

The high frame rate image obtainer 340 may be configured to obtain high frame rate image data 343 from any or all image sensor system 220 of the surveillance system 200. The high frame rate image obtainer 340 may be configured to obtain high frame rate image data 343 correspondingly to how the low frame rate image obtainer 320 may be configured to obtain low frame rate image data 323 as exemplified above.

The high frame rate image obtainer 340 may be configured to store the high frame rate image data 343 on a storage device such as the storage device 120 of the computer system 100. Additionally, or alternatively, the high frame rate image obtainer 340 may be configured to provide the high frame rate image data 343 to a display device of the surveillance system 200.

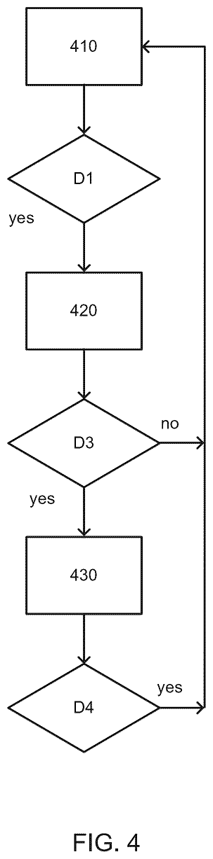

The processing circuitry 110 of the computer system 100, the processing circuitry 210 of the surveillance system 200 and/or the surveillance system manager 300 may be configured to control the surveillance system 200 as shown in the flowchart of FIG. 4. The surveillance system 200 is controlled to enter a first state 410, a power saving state 410 or low power state for the predetermined sleep time 312. At a first decision point D1 it is determined if the predetermined sleep time 312 has lapsed. If the predetermined sleep time 312 has not lapsed, the surveillance system 200 remains at the power saving state 410. If, at the first decision point D1 it is determined that the predetermined sleep time 312 has lapses, the surveillance system is controlled to enter a second state 420, a detection power state 420 or medium power state. In FIG. 4, the control of the surveillance system 200 at the power saving state 410 is indicated to be a polling process, but this is for illustrative purposes and the surveillance system 200 may be controlled at the power saving state 410 as exemplified with reference to FIG. 3 and the wakeup controller 310.

At the power saving state 410, a minimum of features of the surveillance system 200 are activated. The power saving state 410 is the lowest power state of the surveillance system 200 and all image sensor systems 220 may be powered off. To avoid leakage currents, at the power saving state 410, all, or at least most, functionality except for that required by the wakeup controller 310, may be powered down. The wakeup controller 310 may be realized as an extremely low power counter or timer provided with a low power clock (RC clock etc.) that generates an interrupt and wakes further processing circuitry 110, 210 responsive to the lapse of the predetermined sleep time 312. A maximum instantaneous power consumption of the surveillance system at the power saving state 410 may be as low as a few μA, and an average power consumption is about the same.

Upon entering the detection power state 420, further features of the surveillance system 200 are activated. At the detection power state 420, the surveillance system 200 may be controlled to obtain low frame rate image data 323, i.e. image data 323, of the surrounding area 205 of the vehicle 10. The low frame rate image data 323 may be obtained by controlling one or more image sensor systems 210 to obtain the low frame rate image data 323 as exemplified in reference to FIG. 3 and the image obtainer 320. Any image sensor system 210 activated in order to obtain the low frame rate image data 323 may be deactivated immediately after the low frame rate image data 323 have been obtained. This reduces power consumption of the surveillance system 200 further. The obtained low frame rate image data 323 is processed to determine presence of the predetermined target 50 in the surrounding area 205. The low frame rate image data 323 may be processed as exemplified with reference to FIG. 3 and the image processor 330. At a second decision point D2 it is determined, by e.g. the image processor 330, if the predetermined target 50 is present in the surrounding area 205. This may be provided by referencing the target indicator 329. If, at a third decision point D3, it is determined that the predetermined target 50 is not present in the surrounding area 205, the surveillance system 200 is once more controlled to enter the power saving state 410 for the predetermined sleep time 312. If, at the third decision point D3, it is determined that the predetermined target 50 is present in the surrounding area 205, the surveillance system 200 may be controlled to enter a third state 430, a monitoring power state 430, or high power state.

At the detection power state 420, at least one image sensor system 210 is activated to obtain the low frame rate image data 323. This consumes significantly more power than the power saving state 410. The difference in power consumption will depend on specifications of the activated image sensor system 210 and configuration of the low frame rate image data 323 obtained. The processing of the low frame rate image data 323 may be comparably low energy by configuring specific hardware circuitry and/or software functions for determining presence of the predetermined target 50 in the surrounding area 205. Further, by processing in more than one step by e.g. as exemplified starting by determining difference in the obtained low frame rate image data 323a compared to previous low frame rate image data 323b prior to performing more complex processing of the low frame rate image data 323.

At the monitoring power state 430, the surveillance system 200 is configured to obtain high frame rate image data 343 from at least one image sensor system 210. The monitoring power state 430 may correspond to the functionality exemplified with reference to FIG. 3 and the video obtainer 440. If, at a fourth decision point D4, it is determined that there is no longer a need to remain at the monitoring power state 430, the surveillance system 200 is once more controlled to enter the power saving state 410 for the predetermined sleep time 312. The surveillance system 200 may be controlled to enter the power saving state 410 for the predetermined sleep time 312 responsive to an external reset such as an operator of vehicle 10 or surveillance personnel providing a reset for the surveillance system 200 in e.g. response to visual confirmation (of the surrounding area 205 and/or the high frame rate image data 343) that the predetermined target 50 in not present in the surrounding area 205. Additionally, or alternatively, the surveillance system 200 may be controlled to enter the power saving state 410 for the predetermined sleep time 312 responsive to processing, by the processing circuitry 110 of the computer system 100, the processing circuitry 210 of the surveillance system 200 and/or the surveillance system manager 300, of the high frame rate image data 343 indicating that the predetermined target 50 in not present in the surrounding area 205.

At the monitoring power state 430, at least one image sensor system 210 is substantially continuously activated in order to provide the high frame rate image data 343. This consumes significantly more power that the detection power state 420.

Although not seen in FIG. 4, the surveillance system 200 may be controlled to enter the monitoring power state 430 responsive to reception of other triggers. Other triggers may be provided by sensor circuitry 16 such as PIR detectors etc. Other triggers may be provided via a user interface of the alarm system 200 where an operator of vehicle 10 may indicate distress. Other triggers may be provided via the communications circuitry 18 of the vehicle 10 where an remote operator of the vehicle 10 or the alarm system may indicate increased awareness.

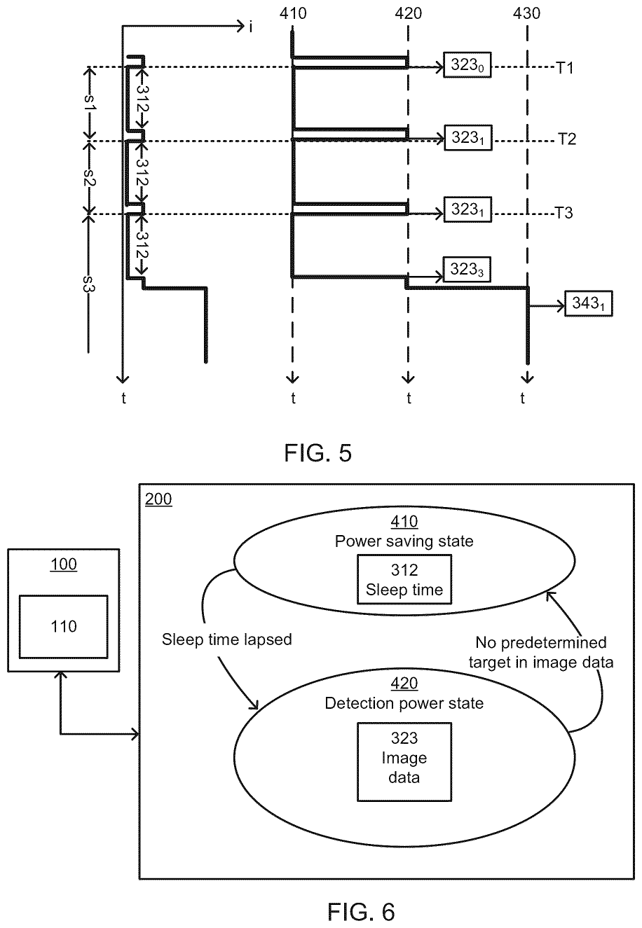

In FIG. 5, an exemplary state chart with associated current consumption i of a surveillance system 200 controlled according to the flowchart presented in FIG. 4. The current consumption i is proportional to a power consumption of the surveillance system 200. The state chart and the current consumption i are shown along common time axis t. At a first point in time T1, the surveillance system 200 enters a first surveillance cycle s1. At the first point in time T1, the surveillance system 200 is controlled to operate at the power saving state 410 for the predetermined sleep time 312. Upon lapse of the predetermined sleep time 312, the surveillance system 200 is controlled to enter the detection power state 420. At the detection power state 420, first low frame rate image data 3231 is obtained and presence of the predetermined target 50 in the surrounding area 205 is determined. Presence of the predetermined target 50 in the surrounding area 205 may be determined based on comparing the first low frame rate image data 323₁ to initial first low frame rate image data 323₀. In FIG. 5, it is, during the first surveillance cycle s1, determined that the predetermined target 50 is not present in the surrounding area 205 and the surveillance system 200 is controlled to operate at the power saving state 410 for the predetermined sleep time 312 at a second surveillance cycle s2 following the first surveillance cycle s1, this occurs at a second point in time T2. During the second surveillance cycle s2, upon lapse of the predetermined sleep time 312, the surveillance system 200 is controlled to enter the detection power state 420. At the detection power state 420, a second low frame rate image data 323₂ is obtained and presence of the predetermined target 50 in the surrounding area 205 is determined. Presence of the predetermined target 50 in the surrounding area 205 may be determined based on comparing the second low frame rate image data 323₂ to the first low frame rate image data 323₁. In FIG. 5, it is, during the second surveillance cycle s2, determined that the predetermined target 50 is not present in the surrounding area 205 and the surveillance system 200 is controlled to operate at the power saving state 410 for the predetermined sleep time 312 at a third surveillance cycle s3 following the second surveillance cycle s2, this occurs at a third point in time T3. During the third surveillance cycle s3, upon lapse of the predetermined sleep time 312, the surveillance system 200 is controlled to enter the detection power state 420. At the detection power state 420, a third low frame rate image data 3233 is obtained and presence of the predetermined target 50 in the surrounding area 205 is determined. Presence of the predetermined target 50 in the surrounding area 205 may be determined based on comparing the third low frame rate image data 323₃ to the first and/or the second low frame rate image data 323₁, 323₂. In FIG. 5, it is, during the third surveillance cycle s3, determined that the predetermined target 50 is present in the surrounding area 205 and the surveillance system 200 is controlled to operate at the monitoring saving state 430.

As seen in FIG. 5, the current consumption i is significantly lower at the power saving state 410 compared to the detection power state 420 and the monitoring power state 430. The current consumption i shown in FIG. 5 is exemplary and it may be that configurations and specifications of the image sensor systems 220 is such that a peak current consumption, i.e. a peak power consumption, during the detection power state 420 may be substantially the same as a peak current consumption during the monitoring power state 430. However, as seen in FIG. 5, average current consumptions, i.e. average power consumptions, of surveillance cycles s1, s2 wherein the monitoring power state 430 is not entered, is significantly lower than an average power consumption of the surveillance cycle s3 wherein the monitoring power state 430 is entered. Controlling the surveillance system 200 as presented by the present disclosure may significantly decrease an average power consumption of the surveillance system 200.

In FIG. 6 an exemplary block diagram of a surveillance system 200 controlled by the computer system 100 is shown. The computer system 100 comprises processing circuitry 110 configured to control the surveillance system 200 to operate at the power saving state 410 for the predetermined sleep time 312 of a first surveillance cycle s1. Upon lapse of the predetermined sleep time 312, the processing circuitry 110 is configured to control the surveillance system 200 to operate at a detection power state 420. At the detection power state 420, the processing circuitry 110 is configured to control the surveillance system 200 to obtain first image data 323 of a surrounding area 205 of a vehicle 10. The processing circuitry 110 is further configured to, at the detection power state 420, process the first image data 323 to determine whether at least one predetermined target 50 is in the surrounding area 205. Upon determining that the predetermined target 50 is not present in the surrounding area 205, the processing circuitry 110 is configured to control the surveillance system 200 to operate at the power saving state 410 for the predetermined sleep time 312 of a second surveillance cycle s2 following the first surveillance cycle s1.

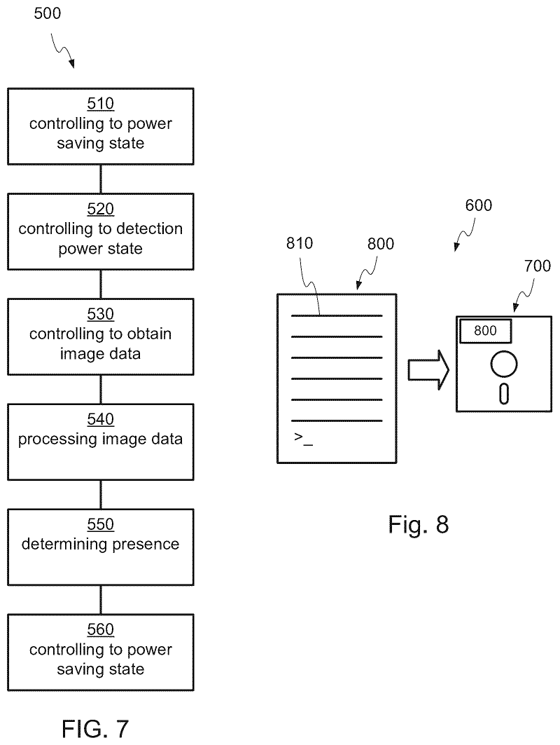

In FIG. 7, an exemplary method 500 for controlling a surveillance system 200 is shown. The method 500 shown in FIG. 7 may be expanded and/or modified to comprise any suitable feature or function presented herein although not specifically mentioned in reference to FIG. 7. For instance, the method 500 may comprise all or some of the actions, functions and features described with reference to FIG. 3, FIG. 4, FIG. 5, and/or FIG. 6. The method 500 may be a computer implemented method and may be performed by the processing circuitry 110 of the computer system 100 and/or the processing circuitry 210 of the surveillance system 200.

The method 500 comprises controlling 510 the surveillance system 200 to operate at the power saving state 410 for the predetermined sleep time 312 of the first surveillance cycle s1. The method 500 further comprises, upon lapse of the predetermined sleep time 312, controlling 520 the surveillance system 200 to operate at the detection power state 420. The method 500 further comprises, at the detection power state 420, controlling 530 the surveillance system 200 to obtain first image data 323 of the surrounding area 205 of the vehicle 10. The method 500 further comprises, at the detection power state 420, processing 540 the first image data 323 to determine 550 whether at least one predetermined target 50 is in the surrounding area 205. The method 500 further comprises, upon determining 550 that the predetermined target 50 is not present in the surrounding area 205, controlling 560 the surveillance system 200 to operate at the power saving state 410 for the predetermined sleep time 312 of a second surveillance cycle s2 following the first surveillance cycle s1.

In FIG. 8 a computer program product 600 is shown. The computer program product 600 comprises a computer program 800 and a non-transitory computer readable medium 700. The computer program 800 may be stored on the computer readable medium 700. The computer readable medium 700 is, in FIG. 8, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 800 comprises instruction 810 e.g. program instruction, software code, that, when executed by processing circuitry cause the processing circuitry to perform the method 500 introduced with reference to FIG. 7.

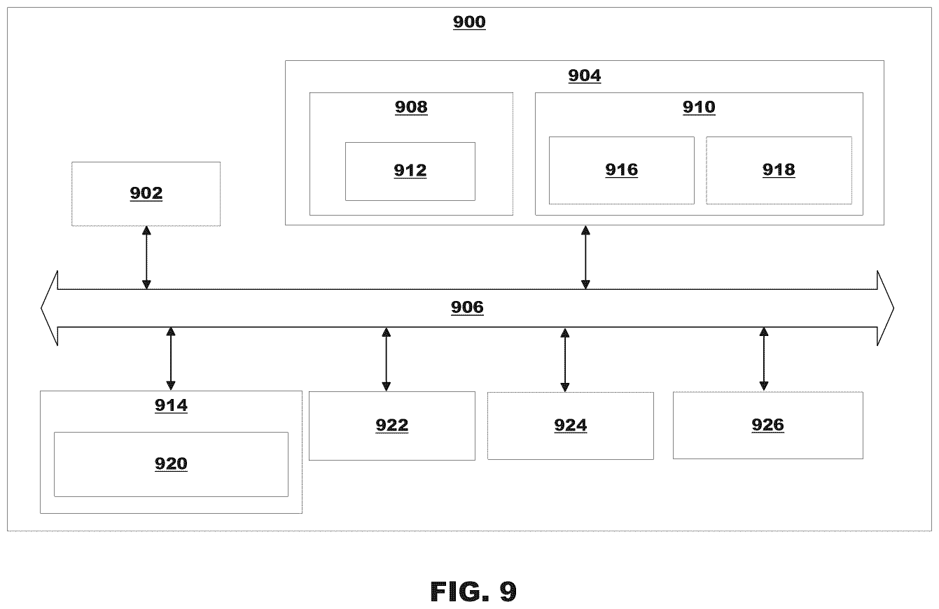

FIG. 9 is a schematic diagram of a computer system 900 for implementing examples disclosed herein. The computer system 900 may be the computer system 100 introduced with reference to FIG. 1. The computer system 900 is adapted to execute instructions from a computer-readable medium to perform these and/or any of the functions or processing described herein. The computer system 900 may be connected (e.g., networked) to other machines in a LAN, an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The processing circuitry 902 may comprise the processing circuitry 110 of the computer system 100 and/or the processing circuitry 210 of the surveillance system 200 introduced with reference to FIG. 1. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non- volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 100 comprising processing circuitry 110 configured to: control a surveillance system 200 to operate at a power saving state 410 for a predetermined sleep time 312 of a first surveillance cycle s1; upon lapse of the predetermined sleep time 312, control the surveillance system 200 to operate at a detection power state 420; at the detection power state 420, control the surveillance system 200 to obtain first image data 323₁ of a surrounding area 205 of a vehicle 10; at the detection power state 420, process the first image data 323₁ to determine whether at least one predetermined target 50 is in the surrounding area 205; upon determining that the predetermined target 50 is not present in the surrounding area 205, control the surveillance system 200 to operate at the power saving state 410 for the predetermined sleep time of a second surveillance cycle s2 following the first surveillance cycle s1.

Example 2. The computer system 100 of example 1, wherein the processing circuitry 110 is further configured to, during the second surveillance cycle s2: upon lapse of the predetermined sleep time 312, control the surveillance system 200 to operate at the detection power state 420; at the detection power state 420, control the surveillance system 200 to obtain second image data 323₂ of the surrounding area 205 of the vehicle 10; at the detection power state 420, process the second image data 323₂ to determine whether at least one predetermined target 50 is in the surrounding area 205; upon determining that the predetermined target 50 is not present in the surrounding area 205, control the surveillance system 200 to operate at the power saving state 410 for the predetermined sleep time of a third surveillance cycle s3 following the second surveillance cycle s2.

Example 3. The computer system 100 of example 1 or 2, wherein the processing circuitry 110 is further configured to: at the detection power state 420, upon determining that the predetermined target 50 is present in the surrounding area 205, control the surveillance system 200 to operate at a monitoring power state 430.

Example 4. The computer system 100 of example 2 or 3, wherein processing the second image data 323₂ to determine whether the at least one predetermined target 50 is present in the surrounding area 205 by processing the image data 323 further comprises processing the image data 323 by comparison of the second image data 323₂ to the first image data 323₁.

Example 5. The computer system 100 of example 4, wherein the processing circuitry 110 is further configured to, at the detection power state 420: upon determining that the second image data 323₂ is substantially different from the first image data 323₁, further process the first image data 323₁ by an item recognition circuitry 324 to determine presence of the predetermined target 50 in the surrounding area 205.

Example 6. The computer system 100 of any one of examples 1 to 5, wherein the processing circuitry 110 is further configured to, at the detection power state 420: obtain the first image data 323₁ from the surveillance system 200, wherein the surveillance system 200 comprises a plurality of image sensor systems 220.

Example 7. The computer system 100 of example 6, wherein the plurality of image sensor systems 220 comprises two or more of a front view image sensor system 220, a rear view image sensor system 220, a right view image sensor system 220, a left view image sensor system 220 or a birds view image sensor system 220.

Example 8. The computer system 100 of example 6 or 7, wherein the processing circuitry 110 is further configured to: obtain image data 323 from a first image sensor subset comprising at least one image sensor system 220 of the plurality of image sensor systems 220 at the first surveillance cycle s1, and obtain image data 323 from a second image sensor subset comprising at least one image sensor system 220 of the plurality of image sensor systems 220 at the second surveillance cycle s2, wherein the first image sensor subset is different from the second image sensor subset.

Example 9. The computer system 100 of any one of examples 6 to 8, wherein the processing circuitry 110 is further configured to: upon a lapse of the predetermined sleep time 312 of each surveillance cycle, control a subset of a plurality of image sensor systems 220 of the surveillance system 200 to operate at the detection power state, wherein each subset of the plurality of image sensor systems 220 is cycled through in an order, the order being at least one of, a predetermined order, a variable order determined depending on targets detected, a random order.

Example 10. The computer system 100 of any one of examples 1 to 9, wherein the processing circuitry 110 is further configured to: at the detection power state 420, obtain first image data 323₁ as a single still image.

Example 11. The computer system 100 of any one of examples 3 to 10, wherein the processing circuitry 110 is further configured to: at the monitoring power state 430, obtain monitoring image data 323 with a higher framerate than the first image data 323₁.

Example 12. The computer system 100 of any one of examples 1 to 11, wherein the predetermined sleep time 312 is 30 s or less.

Example 13. The computer system 100 of any one of examples 1 to 12, wherein the processing circuitry 110 is further configured to: upon obtaining sensor data, from sensor circuitry 16 of the vehicle 10, indicating movement at the surrounding area 205 of a vehicle 10, wake up from the power saving state 410 to the detection power state 420.

Example 14. The computer system 100 of any one of examples 1 to 13, wherein the predetermined target 50 is a person and/or a suspicious object.

Example 15. The computer system 100 of any one of examples 1 to 14, wherein the detection power state 420 consumes more power than the power saving state 410 and the monitoring power state 430 consumes more power than the detection power state 420.

Example 16. The computer system 100 of example 1, wherein the processing circuitry 110 is further configured to: during the second surveillance cycle s2: upon lapse of the predetermined sleep time 312, control the surveillance system 200 to operate at the detection power state 420; at the detection power state 420, control the surveillance system 200 to obtain second image data 323₂ of the surrounding area 205 of the vehicle 10; at the detection power state 420, process the second image data 323₂ to determine whether at least one predetermined target 50 is in the surrounding area 205; upon determining that the predetermined target 50 is not present in the surrounding area 205, control the surveillance system 200 to operate at the power saving state 410 for the predetermined sleep time of a third surveillance cycle s3 following the second surveillance cycle s2; upon determining that the predetermined target 50 is present in the surrounding area 205, control the surveillance system 200 to operate at a monitoring power state 430; wherein processing the second image data 323₂ to determine whether the at least one predetermined target 50 is present in the surrounding area 205 by processing the image data 323 further comprises processing the image data 323 by comparison of the second image data 323₂ to the first image data 323₁; wherein the processing circuitry 110 is further configured to, at the detection power state 420: upon determining that the second image data 323₂ is substantially different from the first image data 323₁, further process the first image data 323₁ by an item recognition circuitry 324 to determine presence of the predetermined target 50 in the surrounding area 205; at the detection power state 420: obtain the first image data 323₁ from the surveillance system 200, wherein the surveillance system 200 comprises a plurality of image sensor systems 220; wherein the plurality of image sensor systems 220 comprises two or more of a front view image sensor system 220, a rear view image sensor system 220, a right view image sensor system 220, a left view image sensor system 220 or a birds view image sensor system 220; obtain image data 323 from a first image sensor subset comprising at least one image sensor system 220 of the plurality of image sensor systems 220 at the first surveillance cycle s1, and obtain image data 323 from a second image sensor subset comprising at least one image sensor system 220 of the plurality of image sensor systems 220 at the second surveillance cycle s2, wherein the first image sensor subset is different from the second image sensor subset; upon a lapse of the predetermined sleep time 312 of each surveillance cycle, control a subset of a plurality of image sensor systems 220 of the surveillance system 200 to operate at the detection power state, wherein each subset of the plurality of image sensor systems 220 is cycled through in an order, the order being at least one of, a predetermined order, a variable order determined depending on targets detected, a random order; at the detection power state 420, obtain first image data 323₁ as a single still image; and, at the monitoring power state 430, obtain monitoring image data 323 with a higher framerate than the first image data 323₁; wherein the predetermined sleep time 312 is 30 s or less; wherein the processing circuitry 110 is further configured to: upon obtaining sensor data, from sensor circuitry 16 of the vehicle 10, indicating movement at the surrounding area 205 of a vehicle 10, wake up from the power saving state 410 to the detection power state 420; wherein the predetermined target 50 is a person and/or a suspicious object; wherein the detection power state 420 consumes more power than the power saving state 410 and the monitoring power state 430 consumes more power than the detection power state 420.

Example 17. A vehicle 10 comprising the computer system 100 of any one of examples 1 to 16.

Example 18. The vehicle 10 of example 17, wherein the power saving state 410 is entered responsive to the vehicle 10 being parked.

Example 19. The vehicle 10 of example 17 or 18, wherein the vehicle 10 is a heavy-duty vehicle.

Example 20. A computer implemented method 500 comprising: controlling 510, by processing circuitry 110 of a computer system 100, surveillance system 200 to operate at a power saving state 410 for a predetermined sleep time 312 of a first surveillance cycle s1; upon lapse of the predetermined sleep time 312, controlling 520, by the processing circuitry 110 of the computer system 100, the surveillance system 200 to operate at a detection power state 420; at the detection power state 420, controlling 530, by the processing circuitry 110 of the computer system 100, the surveillance system 200 to obtain first image data 323₁ of a surrounding area 205 of a vehicle 10; at the detection power state 420, processing 540, by the processing circuitry 110 of the computer system 100, the first image data 323₁ to determine 550 whether at least one predetermined target 50 is in the surrounding area 205; upon determining 550 that the predetermined target 50 is not present in the surrounding area 205, controlling 560, by the processing circuitry 110 of the computer system 100, the surveillance system 200 to operate at the power saving state 410 for the predetermined sleep time of a second surveillance cycle s2 following the first surveillance cycle s1.

Example 21. The computer implemented method 500 of example 20, further comprising: upon lapse of the predetermined sleep time 312, controlling, by the processing circuitry 110 of the computer system 100, the surveillance system 200 to operate at the detection power state 420; at the detection power state 420, controlling, by the processing circuitry 110 of the computer system 100, the surveillance system 200 to obtain second image data 323₂ of the surrounding area 205 of the vehicle 10; at the detection power state 420, processing, by the processing circuitry 110 of the computer system 100, the second image data 323₂ to determine whether at least one predetermined target 50 is in the surrounding area 205; upon determining that the predetermined target 50 is not present in the surrounding area 205, controlling, by the processing circuitry 110 of the computer system 100, the surveillance system 200 to operate at the power saving state 410 for the predetermined sleep time of a third surveillance cycle s3 following the second surveillance cycle s2.

Example 22. The computer implemented method 500 of example 20 or 21, further comprising: at the detection power state 420, upon determining that the predetermined target 50 is present in the surrounding area 205, controlling, by the processing circuitry 110 of the computer system 100, the surveillance system 200 to operate at a monitoring power state 430.

Example 23. The computer implemented method 500 of example 21 or 22, wherein processing the second image data 323₂ to determine whether the at least one predetermined target 50 is present in the surrounding area 205 by processing, by the processing circuitry 110 of the computer system 100, the image data 323 further comprises processing the image data 323 by comparison of the second image data 323₂ to the first image data 323₁.

Example 24. The computer implemented method 500 of example 23, further comprising: upon determining that the second image data 323₂ is substantially different from the first image data 323₁, further processing, by the processing circuitry 110 of the computer system 100, the first image data 323₁ by an item recognition circuitry 324 to determine presence of the predetermined target 50 in the surrounding area 205.

Example 25. The computer implemented method 500 of any one of examples 20 to 24, further comprising: obtaining, by the processing circuitry 110 of the computer system 100, the first image data 323₁ from the surveillance system 200, wherein the surveillance system 200 comprises a plurality of image sensor systems 220.

Example 26. The computer implemented method 500 of example 24 or 25, further comprising: obtaining, by the processing circuitry 110 of the computer system 100, image data 323 from a first image sensor subset comprising at least one image sensor system 220 of a plurality of image sensor systems 220 of the surveillance system 200 at the first surveillance cycle s1, and obtaining, by the processing circuitry 110 of the computer system 100, image data 323 from a second image sensor subset comprising at least one image sensor system 220 of the plurality of image sensor systems 220 at the second surveillance cycle s2, wherein the first image sensor subset is different from the second image sensor subset.

Example 27. The computer implemented method 500 of any one of examples 24 to 26, further comprising: upon a lapse of the predetermined sleep time 312 of each surveillance cycle, controlling, by the processing circuitry 110 of the computer system 100, a subset of a plurality of image sensor systems 220 of the surveillance system 200 to operate at the detection power state, wherein each subset of the plurality of image sensor systems 220 is cycled through in an order, the order being at least one of, a predetermined order, a variable order determined depending on targets detected, a random order.

Example 28. The computer implemented method 500 of any one of examples 20 to 27, further comprising: at the detection power state 420, obtaining, by the processing circuitry 110 of the computer system 100, first image data 323₁ as a single still image.

Example 29. The computer implemented method 500 of any one of examples 20 to 28, further comprising: at the monitoring power state 430, obtaining, by the processing circuitry 110 of the computer system 100, monitoring image data 323 with a higher framerate than the first image data 323₁.

Example 30. The computer implemented method 500 of any one of examples 20 to 29, further comprising: upon obtaining, by the processing circuitry 110 of the computer system 100, sensor data, from sensor circuitry 16 of the vehicle 10, indicating movement at the surrounding area 205 of a vehicle 10, waking up, by the processing circuitry 110 of the computer system 100, from the power saving state 410 to the detection power state 420.

Example 31.A computer program product comprising program code for performing, when executed by the processing circuitry, the method of any of examples 20 to 30.

Example 32. A non-transitory computer-readable storage medium comprising instructions, which when executed by the processing circuitry, cause the processing circuitry to perform the method of any of examples 20 to 30.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
control a surveillance system to operate at a power saving state for a predetermined sleep time of a first surveillance cycle;
upon lapse of the predetermined sleep time, control the surveillance system to operate at a detection power state;
at the detection power state, control the surveillance system to obtain first image data of a surrounding area of a vehicle;
at the detection power state, process the first image data to determine whether at least one predetermined target is in the surrounding area; and
upon determining that the predetermined target is not present in the surrounding area, control the surveillance system to operate at the power saving state for the predetermined sleep time of a second surveillance cycle following the first surveillance cycle.

2. The computer system of claim 1, wherein the processing circuitry is further configured to, during the second surveillance cycle:
upon lapse of the predetermined sleep time, control the surveillance system to operate at the detection power state;
at the detection power state, control the surveillance system to obtain second image data of the surrounding area of the vehicle;
at the detection power state, process the second image data to determine whether at least one predetermined target is in the surrounding area; and
upon determining that the predetermined target is not present in the surrounding area, control the surveillance system to operate at the power saving state for the predetermined sleep time of a third surveillance cycle following the second surveillance cycle.

3. The computer system of claim 1, wherein the processing circuitry is further configured to:
at the detection power state, upon determining that the predetermined target is present in the surrounding area, control the surveillance system to operate at a monitoring power state.

4. The computer system of claim 2, wherein processing the second image data to determine whether the at least one predetermined target is present in the surrounding area by processing the image data further comprises processing the image data by comparison of the second image data to the first image data.

5. The computer system of claim 4, wherein the processing circuitry is further configured to, at the detection power state:
upon determining that the second image data is substantially different from the first image data, further process the first image data by an item recognition circuitry to determine presence of the predetermined target in the surrounding area.

6. The computer system of claim 1, wherein the processing circuitry is further configured to, at the detection power state:
obtain the first image data from the surveillance system, wherein the surveillance system comprises a plurality of image sensor systems.

7. The computer system of claim 6, wherein the plurality of image sensor systems comprises two or more of a front view image sensor system, a rear view image sensor system, a right view image sensor system, a left view image sensor system or a birds view image sensor system.

8. The computer system of claim 6, wherein the processing circuitry is further configured to:
obtain image data from a first image sensor subset comprising at least one image sensor system of the plurality of image sensor systems at the first surveillance cycle, and obtain image data from a second image sensor subset comprising at least one image sensor system of the plurality of image sensor systems at the second surveillance cycle, wherein the first image sensor subset is different from the second image sensor subset.

9. The computer system of claim 6, wherein the processing circuitry is further configured to:
upon a lapse of the predetermined sleep time of each surveillance cycle, control a subset of a plurality of image sensor systems of the surveillance system to operate at the detection power state,
wherein each subset of the plurality of image sensor systems is cycled through in an order, the order being at least one of, a predetermined order, a variable order determined depending on targets detected, a random order.

10. The computer system of claim 1, wherein the processing circuitry is further configured to: at the detection power state, obtain first image data as a single still image.

11. The computer system of claim 1, wherein the predetermined sleep time is 30 s or less.

12. The computer system of claim 1, wherein the processing circuitry is further configured to: upon obtaining sensor data, from sensor circuitry of the vehicle, indicating movement at the surrounding area of a vehicle, wake up from the power saving state to the detection power state.

13. The computer system of claim 1, wherein the detection power state consumes more power than the power saving state and the monitoring power state consumes more power than the detection power state.

14. The computer system of claim 1, wherein the processing circuitry is further configured to:
during the second surveillance cycle, upon lapse of the predetermined sleep time, control the surveillance system to operate at the detection power state; at the detection power state, control the surveillance system to obtain second image data of the surrounding area of the vehicle; at the detection power state, process the second image data to determine whether at least one predetermined target is in the surrounding area; upon determining that the predetermined target is not present in the surrounding area, control the surveillance system to operate at the power saving state for the predetermined sleep time of a third surveillance cycle following the second surveillance cycle;
at the detection power state, upon determining that the predetermined target is present in the surrounding area, control the surveillance system to operate at a monitoring power state;
at the detection power state, upon determining that the second image data is substantially different from the first image data, further process the first image data by an item recognition circuitry to determine presence of the predetermined target in the surrounding area;
at the detection power state, obtain the first image data from the surveillance system, wherein the surveillance system comprises a plurality of image sensor systems;
obtain image data from a first image sensor subset comprising at least one image sensor system of the plurality of image sensor systems at the first surveillance cycle, and obtain image data from a second image sensor subset comprising at least one image sensor system of the plurality of image sensor systems at the second surveillance cycle, wherein the first image sensor subset is different from the second image sensor subset; and
upon a lapse of the predetermined sleep time of each surveillance cycle, control a subset of a plurality of image sensor systems of the surveillance system to operate at the detection power state, wherein each subset of the plurality of image sensor systems is cycled through in an order, the order being at least one of, a predetermined order, a variable order determined depending on targets detected, a random order,
wherein processing the second image data to determine whether the at least one predetermined target is present in the surrounding area by processing the image data further comprises processing the image data by comparison of the second image data to the first image data.

15. A vehicle comprising the computer system of claim 1.

16. The vehicle of claim 15, wherein the power saving state is entered responsive to the vehicle being parked.

17. The vehicle of claim 15, wherein the vehicle is a heavy-duty vehicle.

18. A computer implemented method comprising:
controlling, by processing circuitry of a computer system, surveillance system to operate at a power saving state for a predetermined sleep time of a first surveillance cycle;
upon lapse of the predetermined sleep time, controlling, by the processing circuitry of the computer system, the surveillance system to operate at a detection power state;
at the detection power state, controlling, by the processing circuitry of the computer system, the surveillance system to obtain first image data of a surrounding area of a vehicle;
at the detection power state, processing, by the processing circuitry of the computer system, the first image data to determine whether at least one predetermined target is in the surrounding area; and
upon determining that the predetermined target is not present in the surrounding area, controlling, by the processing circuitry of the computer system, the surveillance system to operate at the power saving state for the predetermined sleep time of a second surveillance cycle following the first surveillance cycle.

19. A computer program product comprising program code for performing, when executed by the processing circuitry, the method of claim 18.

20. A non-transitory computer-readable storage medium comprising instructions, which when executed by the processing circuitry, cause the processing circuitry to perform the method of clam 18.
